(19) United States
(12) Patent Application Publication
(10) Pub. No.: US 2005/0180896 A1
(43) Pub. Date: Aug. 18, 2005

(54) Test tube holder

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS COMPANY, LTD., Kumamoto-shi (JP)

(21) Appl. No.: 11/057,177

(22) Filed: Feb. 15, 2005

(30) Foreign Application Priority Data
Feb. 17, 2004 (JP) 2004-040022

(51) Int. Cl. B01L 9/00

(52) U.S. Cl. 422/104

(57) ABSTRACT

A test tube holder has a holder main body, which has a cylindrical hollow portion for containing a test tube, and a test tube attachment adapter arranged in the cylindrical hollow portion. The test tube attachment adapter for holding a test tube is configured by plural leaf springs and coil springs and. Each of the leaf springs has a fixed portion, an elastic deformable portion and a test tube holding piece. The fixed portion is fixed to the inner circumference of the cylindrical hollow portion along the axial direction thereof. The elastic deformable portion extends along the circumferential direction from the fixed portion toward the center axis while leaning in the centripetal direction. The test tube holding piece is formed integrally with the elastic deformable portion. The coil springs bundle a top and a bottom end portions of the plural test tube holding pieces.

### CROSS-REFERENCE TO RELATED APPLICATIONS

This application is based upon and claims the benefit of priority from prior Japanese Patent Application No. 2004-040022, filed Feb. 17, 2004, the entire contents of which are incorporated herein by reference.

### BACKGROUND OF THE INVENTION

1. Field of the Invention

The present invention relates to a test tube holder to be used to transfer a test tube so as to preparatively take or preparatively supply a sample such as blood contained in the test tube.

2. Description of the Related Art

A test tube in which a sample such as blood is contained is made of transparent glass, and a cap made of rubber or a synthetic resin material is attached to the top opening of the test tube. In order to preparatively take or preparatively supply the sample contained in the test tube, the test tube is transferred to respective processing units in a state in which it is held upright by a test tube holder that is guided along a transfer route.

Therefore, such a test tube holder is so configured as to transfer the test tube while keeping it upright in a stable manner. The test tube holder has a base body that configures a holder main body. This base body has engaging units that are engaged with guide rails of a transfer system, on the outer circumferential surface of the proximal end portion thereof. In the axis center portion of the base body, a cylindrical hollow portion for containing a test tube is formed from the top end toward the base end of the base body to a predetermined depth. A test tube holder comprising a test tube attachment adaptor that selectively holds test tubes of different outer diameters inside a cylindrical hollow portion thereof is disclosed in Jpn. Pat. Appln. KOKAI Publication No. 2003-211006.

The test tube holder disclosed in Jpn. Pat. Appln. KOKAI Publication No. 2003-211006 comprises, in particular, a plurality of leaf springs inside the cylindrical hollow portion in the holder main body. Each of the leaf springs has a contact portion that contacts the outer circumferential surface of a test tube to be held. Further, in order to push the contact portion against the outer circumferential surface of the test tube with constant force, each of the leaf springs has an O-ring that encircles and bundles the outer surfaces of the plural leaf springs.

As explained above, the test tube holder according to the prior art has a complicated structure, where the elasticity of the leaf springs is supplemented with one O-ring. Therefore, its assembly workability is poor, manufacturing costs may be increased, and further maintenance is troublesome when the O-ring has damaged.

### BRIEF SUMMARY OF THE INVENTION

An object of the present invention is to simplify the structure of a test tube holder to thereby improve the assembly workability and durability of the test tube holder.

A test tube holder according to the present invention comprises a holder main body and a test tube attachment adapter. The holder main body has a cylindrical hollow portion for containing a test tube. The test tube attachment adapter is attached inside the cylindrical hollow portion of the holder main body, and selectively holds test tubes of different outer diameters. The test tube attachment adapter is configured by a plurality of leaf springs and coil springs. The respective leaf springs are arranged at a nearly constant interval in the circumferential direction of the cylindrical hollow portion, and each have a fixed portion, an elastic deformable portion and a test tube holding piece. The fixed portion is arranged at one side edge along the axial direction of the cylindrical hollow portion, and fixed to the inside of the cylindrical hollow portion. The elastic deformable portion extends along the circumferential direction of the cylindrical hollow portion integrally from the fixed portion while leaning in the centripetal direction thereof. The test tube holding piece is arranged at the central portion of the cylindrical hollow portion integrally with the elastic deformable portion, and extends in the axial direction of the cylindrical hollow portion. The coil spring is of a ring shape, and bundles the top end portion and the bottom end portion of each test tube holding piece.

In this case, in a preferred configuration of the holder main body, slits continuing in the axial direction are arranged in the inter circumferential surface of the cylindrical hollow portion at a constant interval in the circumferential direction, and the fixed portions of the respective leaf springs are inserted into the slots and fixed thereto.

Further, it is also preferred that the top end portion of each test tube holding piece is bent in the centrifugal direction at the top end opening portion of the holder main body, thereby forming a test tube insertion guide portion.

According to the test tube holder of the present invention, the structure thereof may be simplified. Therefore, it is possible to improve the assembly workability thereof, so that the production unit price thereof can be reduced. Furthermore, because the structure thereof is simple, the possibility of damage to each portion is reduced, and durability thereof is excellent.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a side view showing a test tube holder of a first embodiment according to the present invention, where the right half portion of a holder main body is shown in a cross-sectional view;

FIG. 2 is a top view of the test tube holder shown in FIG. 1 viewed from the top end opening portion side; and

FIG. 3 is a perspective view of a service condition where a test tube is inserted into the test tube holder shown in FIG. 1.

### DETAILED DESCRIPTION OF THE INVENTION

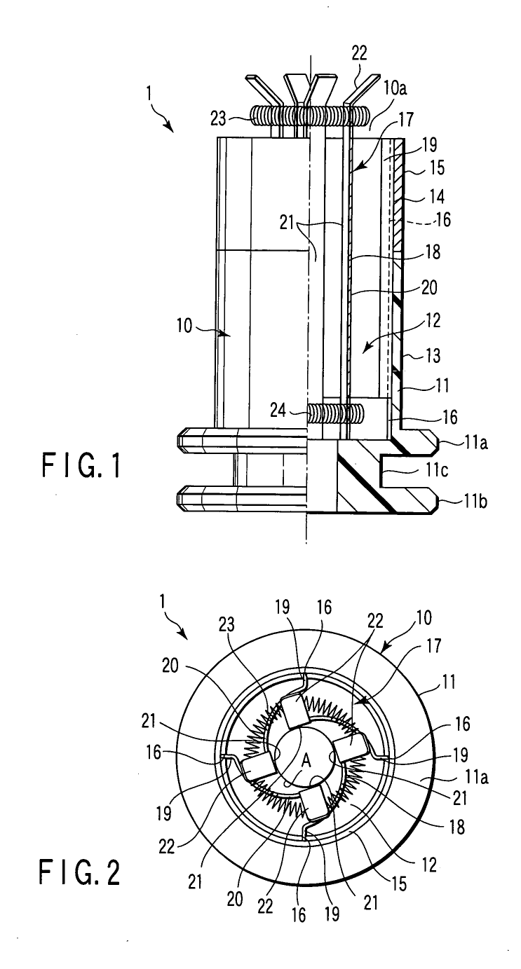

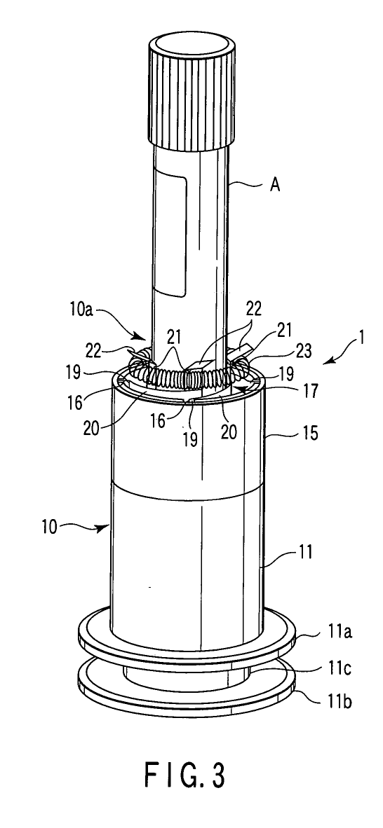

A test tube holder 1 according to an embodiment of the present invention will be explained in detail hereinafter with reference to FIGS. 1 to 3.

The test tube holder 1 of the present embodiment comprises a holder main body 10 and a test tube attachment adapter 17. The holder main body 10 is formed of a synthetic resin material. In the holder main body 10, engaging portions that may be engaged with transfer system guide rails (not shown), i.e., flange portions 11a and 11b of two vertical stages in the embodiment, are formed on the outer circumferential surface of the proximal end portion of a cylindrical base body 11, and a ring slot 11c is arranged between the flange portions.

At the axis center portion of the cylindrical base body 11, a cylindrical hollow portion 12 for inserting a test tube is arranged from the top end portion to a depth equivalent to the position of the flange portion 11a at the upper stage. The outer circumference of the middle area of the cylindrical base body 11 in the longitudinal direction thereof is a large diameter portion 13. The outer circumference of the top end portion of the cylindrical base body 11 next to the large diameter portion 13 is a small diameter portion 14. A metal fastening ring 15 is engaged with the small diameter portion 14. The fastening ring 15 also functions as an indication portion whose existence may be detected by an optical detector or the like.

Plural slits 16, four slits in this embodiment, are formed in the inner circumferential surface of the cylindrical hollow portion 12 along the axial direction from the bottom portion continuously to the top end opening edge of the cylindrical hollow portion 12. The slits 16 are arranged in the circumferential direction at a constant interval.

The test tube attachment adapter 17 is arranged in the cylindrical hollow portion 12, and holds a test tube A in which a sample such as a blood specimen is contained. The test tube attachment adapter 17 comprises plural leaf springs 18, four leaf springs in this embodiment, arranged along the inner circumferential surface of the cylindrical hollow portion 12 at a constant interval. Each of the leaf springs 18 has a fixed portion 19, an elastic deformable portion 20 and a test tube holding piece 21. The fixed portion 19 is arranged at one side edge of each of the leaf springs 18, and is inserted into the slit 16 and fixed therein. The elastic deformable portion 20 extends along the circumferential direction while centripetally leaning from the fixed portion 19 toward the center of the cylindrical hollow portion 12, and is formed into an arc shape in the plane view viewed in direction along the center axis of the cylindrical hollow portion 12. The test tube holding piece 21 extends in a direction along the axis core at the center of the cylindrical hollow portion 12, and is arranged integrally with the elastic deformable portion 20.

The test tube holding pieces 21, four pieces in total, are arranged substantially in parallel at the center of the cylindrical hollow portion 12. The four test tube holding pieces 21 are so configured as to elastically hold the body of the test tube A, and hold the test tube A upright. At the side of the top end opening portion 10a of the holder main body 10, the top end portions of the four test tube holding pieces 21 are bent toward the centrifugal direction, thereby a test tube insertion guide portion 22 is formed.

Further, the top end portions and bottom end portions of the respective test tube holding pieces 21 are bundled by ring-shapes coil springs 23 and 24. The coil springs 23 and 24 do not elastically gather the bundled plural test tube holding pieces 21 toward the center of the cylindrical hollow portion 12, but have elasticity of extending to the degree of expanding the diameter when the test tube A is inserted into the test tube attachment adapter 17. Further, the coil springs 23 and 24 also work so as to protect the elastic deformable portions 20 including the test tube holding pieces 21 that repeatedly deform elastically.

The coil springs 23 and 24 bundle two portions of the top end portion and the bottom end portion of the test tube holding pieces 21. Even when external force caused by dropping the test tube A is applied to the test tube A inserted into the test tube attachment adapter 17, the test tube attachment adapter 17 is protected, and therefore, it is possible to improve the durability of the test tube attachment adapter 17.

Moreover, the slits 16 arranged in the inner circumferential surface of the cylindrical hollow portion 12 extend in the axial direction, and pass through to the top end opening edge of the cylindrical hollow portion 12. Accordingly, when the leaf springs 18 are to be assembled into the cylindrical hollow portion 12, they may be inserted through the top end opening edge of the cylindrical hollow portion 12, so that the assembly workability can be improved.

Note that, the present invention is not limited to the embodiment, but it may be well understood by those skilled in the art that the invention may be embodied by modifying the structural components thereof without departing from the spirit or essential characteristics thereof. Further, various inventions may be formed by appropriate combinations of plural structural components disclosed in the embodiment mentioned above. For example, structural components that are not disclosed in the claims may be removed from all the structural components shown in the embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A test tube holder comprising:
a holder main body having a cylindrical hollow portion to contain a test tube; and
a test tube attachment adapter which is attached inside the cylindrical hollow portion, and which can selectively hold test tubes of different outer diameters, wherein
the test tube attachment adapter is configured by:
plural leaf springs which are arranged at nearly constant intervals in a circumferential direction of the cylindrical hollow portion, a fixed portion that is arranged at one side edge in a direction along a center axis of the cylindrical hollow portion being fixed to the cylindrical hollow portion, an elastic deformable portion extending integrally from the fixed portion toward the center axis while leaning in the circumferential direction of the cylindrical hollow portion, and a test tube holding piece being formed integrally with the elastic deformable portion at a central portion of the cylindrical hollow portion in the direction along the center axis; and
ring-shaped coil springs which bundle the top end portions and the bottom end portions of said plurality of test tube holding pieces.

2. A test tube holder according to claim 1, wherein
the holder main body has slits continuing in the direction along the center axis in an inter circumferential surface of the cylindrical hollow portion which are arranged in the circumferential direction at a constant interval, and
the fixed portions of the respective leaf springs are inserted into the slits and fixed thereto.

3. A test tube holder according to claim 1, wherein
the top end portion of said plurality test tube holding pieces is bent in a centrifugal direction at a top end opening portion of the holder main body, thereby forming a test tube insertion guide portion.

4. A test tube holder according to claim 2, wherein
the top end portion of said plurality of test tube holding pieces is bent in a centrifugal direction at a top end opening portion of the holder main body, thereby forming a test tube insertion guide portion.
